(19) United States
(12) Patent Application Publication
(10) Pub. No.: US 2010/0189507 A1
(43) Pub. Date: Jul. 29, 2010

(54) Method and product for absorbing and consolidating nuisance water or slurry accumulations

(76) Inventor: Duncan Hird, Doncaster (GB)

Correspondence Address: FLOYD B. CAROTHERS;CAROTHERS AND CAROTHERS, 445 FORT PITT BOULEVARD, SUITE 200, PITTSBURGH, PA, 15219, US

(21) Appl. No.: 12/657,808

(22) Filed: Jan. 28, 2010

Related U.S. Application Data
(60) Provisional application No. 61/206,533, filed on Jan. 29, 2009.

(51) Int. Cl. E02B 13/00; C09K 3/00

(52) U.S. Cl. 405/52; 252/194

(57) ABSTRACT

Nuisance water or slurry accumulations on roadways, such as underground mine roadways, are absorbed and consolidated by providing flexible porous containers that are filled with a mixture of a dry cementitious material and absorbent particulate material. The filled containers are applied to an area of nuisance water or slurry accumulation whereby the accumulation is absorbed by the mixture and consolidates through hydration to provide a dried load bearing roadway surface.

This application claims the benefit of U.S. Provisional Application No. 61/206,533, filed Jan. 29, 2009, entitled A METHOD AND PRODUCT TO ABSORB AND CONSOLIDATE NUISANCE AND SLURRY ACCUMULATIONS, the contents of which are incorporated herein in their entirety by reference.

### BACKGROUND OF THE INVENTION

This invention relates generally to techniques and products for absorbing and consolidating nuisance water or slurry accumulations on a roadway surface, such as found in underground mines, in order to allow the safe passage of vehicles and prevent further rutting.

The presence of water in underground roadways has always posed a problem for mining operations. On the other hand, water is essential to suppress airborne dust, to cool down motors, and treat fires, but its presence underfoot is none the less undesirable. Accumulations of such nuisance water and slurry are usually found in transport roadways within the mine making it difficult and some times hazardous for the operation of vehicles. Accumulations are also found in conveyor roadways where water is used to suppress dust. This usually results in large accumulations around conveyor drives and return ends, which is undesirable for conveyor operations and maintenance. Previously, such accumulations have been either filled with inert debris, dammed off, or ignored, none of which offers a desirable or permanent solution.

### SUMMARY OF THE INVENTION

The present invention provides a method and product for absorbtion and consolidation of nuisance water or slurry accumulations on a roadway surface wherein porous flexible containers filled with a mixture of dry cementitious material and absorbent particulate material are applied to an area of nuisance water or slurry accumulation, whereby the accumulation is absorbed by the mixture and consolidate through hydration to provide a dry load bearing roadway surface.

Although the invention is primarily directed for treatment of accumulations of water and slurry in underground mines to allow safe passage of vehicles and to prevent further rutting, nevertheless, it is recognized that the present invention could also be applicable to various other uses, such as flood defense, rehabilitation of above ground road surfaces and the treatment of domestic flooding.

### BRIEF DESCRIPTION OF THE DRAWINGS

Other objects and advantages are disclosed in the accompanying drawings. The accompanying drawings show, for the purpose of exemplification, without limiting the scope of the invention or appended claims, certain practical embodiments of the present invention wherein:

FIG. 1 is a plan of top view of a pod or container made in accordance with the teachings of the present invention for absorbing and consolidating nuisance water or slurry accumulations on a roadway;

FIG. 2 is a sectional view of the container shown in FIG. 1 as seen along section line II-II;

FIG. 3 is a top or plan view of another embodiment of a container for use in the method of the present invention;

FIG. 4 is a sectional view of the container shown in FIG. 3 as seen along section line IV-IV;

FIG. 5 is a top or plan view of another embodiment illustrating the product and method of the present invention which is constructed in a mattress configuration;

FIG. 6 is a cross sectional view of the container shown in FIG. 5 as seen along section line VI-VI;

FIG. 7 is a top or plan view of yet another embodiment of the present invention illustrating a mattress type configuration for the product similar to that illustrated in FIG. 5; and

FIG. 8 is a view in cross section of the embodiment shown in FIG. 7 as seen along section line VIII-VIII.

### DETAILED DESCRIPTION OF THE PREFERRED EMBODIMENTS

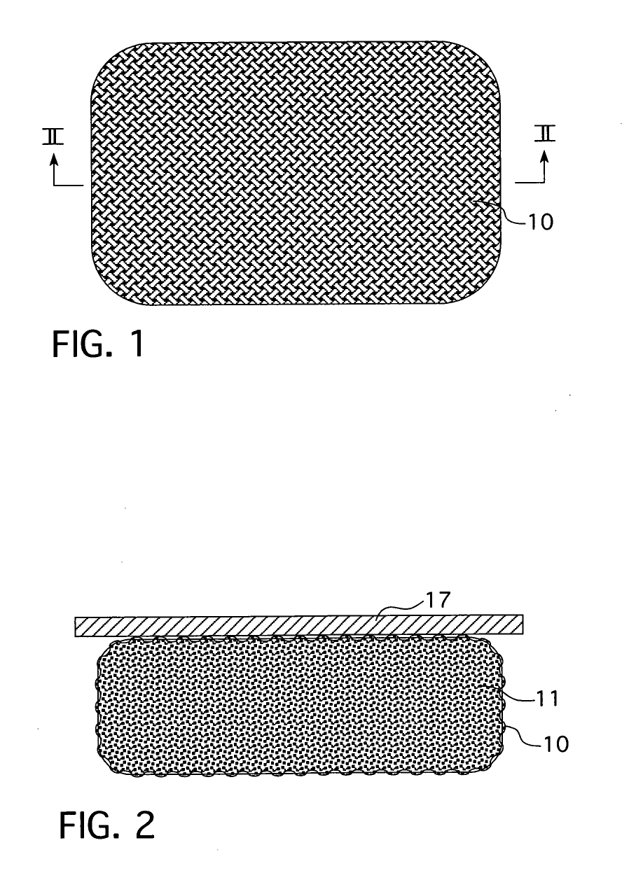

Referring to the embodiment illustrated in FIGS. 1 and 2, a porous flexible container 10 is filled with a mixture 11 of a dry cementitious material and absorbent particulate material. The flexible container 10 is made of an approved fire resistant material that is either perforated or naturally capable of water penetration. Examples of the fire resistant material used for containers 10 is a woven wire reenforced fabric currently used for underground pumpable crib supports, burlap, hessian or perforated waterproof material, such as a perforated plastic. If perforated waterproof material is used for the container 10, removable peel-off strips may be provided which initially cover the perforations so that the mixture 11 remains dry prior to application or use.

When wire reenforced fabric is utilized for container 10, it acts as a formwork so that the containers have a predetermined desired shape. The containers 10 are placed side by side in a uniform fashion to form a raft with a predetermined thickness and depth on a water or slurry accumulation. For deeper water or slurry depths, the containers can be placed on top of each other to form a raft or platform of double thickness, and so on.

Once the pod containers 10 are in place they are left to absorb water so that the cementitious material can start its hydration process. The same mixture 11 that is contained in the containers 10 may also be used in loose conjunction with the containers 10 as loose product to consolidate the associated sludge which will form around and between the containers 10 as they absorb water. Also, although the compound or mixture 11 may have rapid setting capabilities, nevertheless, it will not immediately have load bearing strength, and in such circumstances immediate use of the roadway upon which the water or slurry accumulations occur can be afforded by placing substantially rigid covers 17 over the applied containers for spreading the load applied to the containers. The substantially rigid covers 17 might be provided, for example, by checker plate, weldmesh, or similar covers designed to spread the vehicle load while the containers 10 gain sufficient strength to allow removal of the covers 17 after full hydration.

The material for container 10 in the embodiment of FIGS. 1 and 2 is a woven wire reenforced fabric as previously explained.

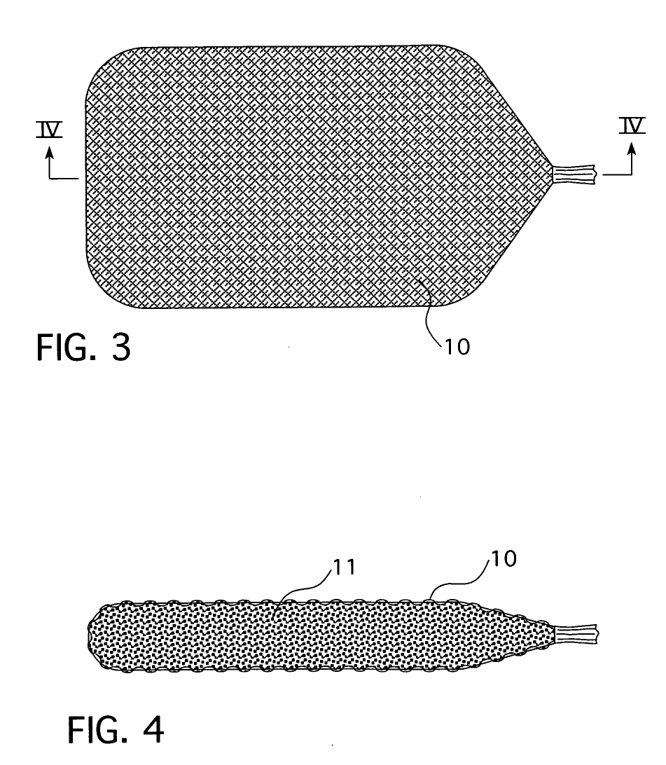

In the embodiment of FIGS. 3 and 4, the material for container 10 is provided in the form of a burlap sack. These burlap sacks can be filled on site or delivered to the site pre-filled with mixture 11 and shrink wrapped to protect the bag from product log and moisture ingress before use. The shrink wrap is then removed prior to placement. Again, loose cementitious product may be used in conjunction with the filled burlap sacks to consolidate the mud into a grout thereby strengthening the structure and reducing the potential for further rutting during vehicle passage.

The dry cementitious material utilized in mixture 11 is typically included in a proportion of between 20% and 50% by weight and the particulate material is included in a proportion of between 1% and 20% by weight. Preferable cementitious materials are calciumsulphoaluminate or calcium aluminate. These are hydraulic cement components which have a relatively high water demand and as such are well suited to the relatively high proportions of water likely to be encountered. The product can also include ordinary Portland cement as a supplementary ingredient which can provide a suitable source of lime. In addition, fillers can be included, such as crushed stone and lightweight clays. Pozzolanic compounds, such as fly ash, are also desirable to absorb water and enhance strength.

The absorbent particulate material included in the mixture 11 may include paper, sawdust, saw shavings or other absorbent materials, which are desirable to take up excess water and therefore allow the cementitious material to hydrate at a faster rate. Set controllers and gelling agents are also desirable in the blend, such as alkali metal aluminate, alkali metal carbonate, aluminum sulfate or other suitable compounds. Aggregates, such as sand and crushed limestone, are also desirable to increase strength and durability. The mixture 11 may also include buoys or buoyant material or weights (not shown) depending upon the conditions present.

A typical cementitious mix for mixture 11 can include, for example, calciumsulphoaluminate in the range of 10% to 50%, calcium sulfate in the range of 20% to 40%, hydrated lime in the range of 5% to 15%, alkali metal salts in the range of 0.2% to 3.5% and pulverized fuel ash in the range of 5% to 25%. All percentages are by weight.

A typical mixture 11 may contain the cementitious component in a proportion of between 20% and 50% by weight and the absorbent particulate material, such as vermiculite/sawdust, between 1% and 20% by weight. The mix can also contain between 50% and 80% aggregate by weight.

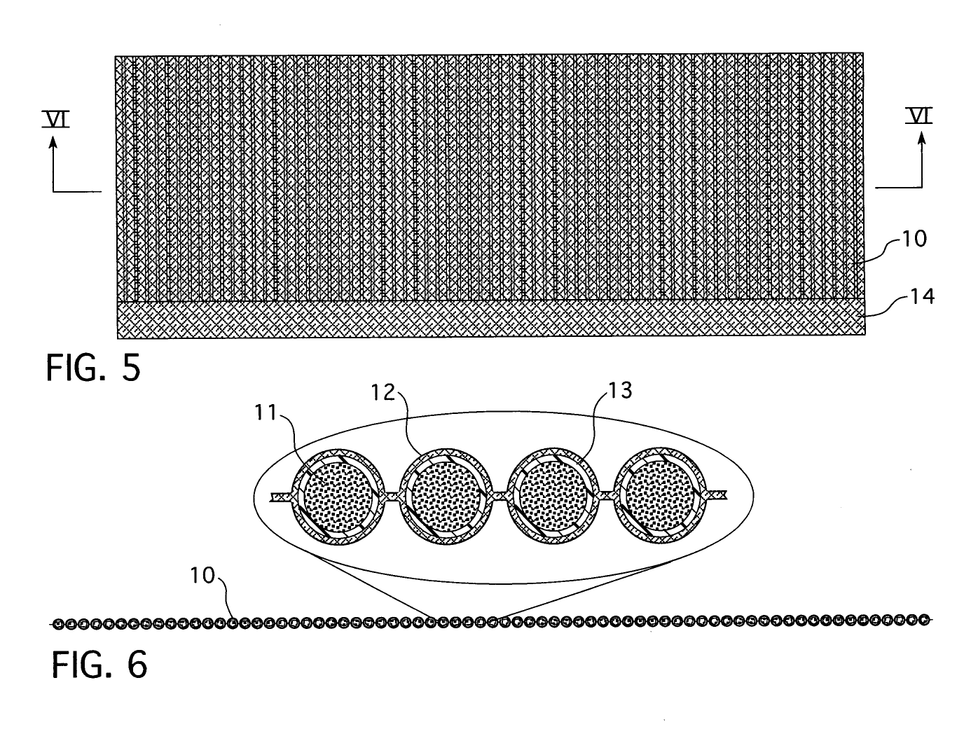

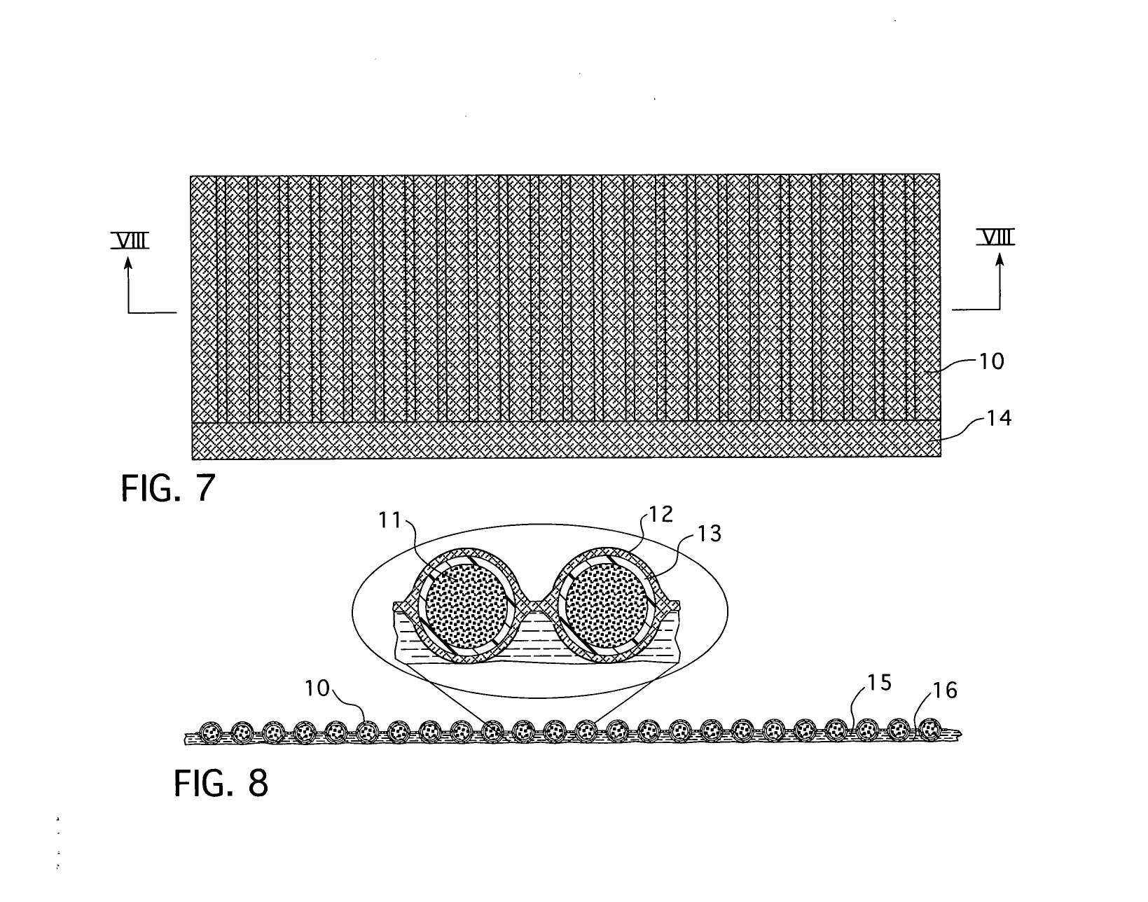

Referring next to the embodiment shown in FIGS. 5 and 6, the container 10 in this embodiment is constructed of burlap as the fabric and the container is constructed in the form of a mattress. The burlap mattress structure consists of a series of tubular pockets 12. This series of pockets 12 are filled with plastic tubes 13, which in turn are filled with the dry mixture 11. The diameter of the tube 12 depend upon the application. The embodiment shown in FIGS. 7 and 8 show substantially the same structure with larger diameter tubes 12.

Once the mattress container 11 is positioned on site in the nuisance water or slurry accumulation 15 on mine roadway 16, the tubes 12 are removed through the open edge 14 of the mattress, and the loose open edge is tied off with tape or stitched to prevent product loss. When all of the individual tubes 12 have been removed and all of the ends have been tied off at the edge 14, the mattress container 10 is laid into the water or slurry accumulation 15.

I claim:

1. A method for absorbing and consolidating nuisance water or slurry accumulations on a roadway comprising;
providing porous flexible containers;
filling said containers with a mixture of a dry cementitious material and absorbent particulate material; and
applying a plurality of said filled containers to an area of nuisance water or slurry accumulation, whereby said accumulation is absorbed by said mixture and consolidates through hydration to provide a dry load bearing roadway surface.

2. The method of claim 1, wherein said absorbent particulate is selected from one or more of wood sawdust, wood shavings, paper and Vermiculite.

3. The method of claim 1, wherein said mixture includes Portland cement.

4. The method of claim 1, wherein said mixture includes fillers.

5. The method of claim 4, said fillers selected from one or more of crushed stone and lightweight clay.

6. The method of claim 1, said mixture including pozzolanic compounds.

7. The method of claim 1, said mixture including set controllers and gelling agents.

8. The method of claim 7, said set controllers and gelling agents selected from alkali metal aluminate, alkali metal carbonate, and aluminum sulfate.

9. The method of claim 1, said cementitious material included in a proportion of between 20% and 50% by weight and said particulate material included in a proportion of between 1% and 20% by weight.

10. The method of claim 1, wherein said cementitious material is selected from one or more of calciumsulphoaluminate or calcium aluminate.

11. The method of claim 10, wherein said cementitious material includes, by weight, calcium sulfoaluminate or calcium aluminate in the range of 10% to 50%, calcium sulfate in the range of 20% to 40%, hydrated lime in the range of 5% to 15%, alkalimetal salts in the range of 0.2% to 3.5%, and pulverized fuel ash in the range of 5% to 25%.

12. The method of claim 11, wherein said mixture includes between 50% and 80% aggregate by weight.

13. The method of claim 12, said aggregate selected from sand and crushed limestone.

14. The method of claim 1, said porous flexible containers selected from burlap, hessian or perforated waterproof material.

15. The method of claim 1, said containers constructed of waterproof material, said containers perforated prior to use.

16. The method of claim 1, said containers constructed of perforated waterproof material with removable peel-off strips covering said perforations.

17. The method of claim 1, said containers constructed of wire reinforced fabric.

18. The method of claim 1, said containers incorporating weights.

19. The method of claim 1, said containers incorporating buoys.

20. The method of claim 1, including the step of placing a substantially rigid cover over said applied containers for spreading load applied to containers.

21. The method of claim 1, said containers shaped as mattresses with a series of pockets lined with removable plastic tubes initially containing said mixture.

22. A pod for absorbing and consolidating nuisance water or slurry accumulations, said pod comprising:
a porous flexible container;
said container containing a mixture of dry cementitious material and absorbent particulate material.

23. The container of claim 22, wherein said absorbent particulate is selected from one or more of wood sawdust, wood shavings, paper or Vermiculite.

24. The container of claim 22, wherein said mixture includes Portland cement.

25. The container of claim 22, wherein said mixture includes fillers.

26. The container of claim 25, said fillers include one or more of crushed stone and lightweight clay.

27. The container of claim 22, said mixture including pozzolanic compounds.

28. The container of claim 22, said mixture including set controllers and gelling agents.

29. The container of claim 28, said set controllers and gelling agents selected from alkali metal aluminate, alkali metal carbonate, and aluminum sulfate.

30. The container of claim 22, said cementitious material included in a proportion of between 20% and 50% by weight and said particulate material included in a proportion of between 1% and 20% by weight.

31. The container of claim 22, wherein said cementitious material includes one or more of calciumsulphoaluminate or calcium aluminate.

32. The container of claim 31, wherein said cementitious material includes, by weight, calcium sulfoaluminate or calcium aluminate in the range of 10% to 50%, calcium sulfate in the range of 20% to 40%, hydrated lime in the range of 5% to 15%, alkalimetal salts in the range of 0.2% to 3.5%, and pulverized fuel ash in the range of 5% to 25%.

33. The container of claim 32, wherein said mixture includes between 50% and 80% aggregate by weight.

34. The container of claim 33, said aggregate selected from sand and crushed limestone.

35. The container of claim 22, said porous flexible containers are burlap, hessian or perforated waterproof material.

36. The container of claim 22, said containers are waterproof material, said containers having perforations.

37. The container of claim 22, said containers are perforated waterproof material with removable peel-off strips covering said perforations.

38. The container of claim 22, said containers are wire reinforced fabric.

39. The container of claim 22, said containers incorporating weights.

40. The container of claim 22, said containers incorporating buoys.

41. The container of claim 22, including a substantially rigid cover over said containers for spreading load applied to containers.

42. said containers shaped as mattresses with a series of pockets lined with removable plastic tubes initially containing said mixture.
